(19) United States
(12) Patent Application Publication
(10) Pub. No.: US 2013/0073956 A1
(43) Pub. Date: Mar. 21, 2013

(54) LINKING PROGRAMMATIC ACTIONS TO USER ACTIONS AT DIFFERENT LOCATIONS

(71) Applicants: Stefan MARTI, Santa Clara, CA (US); Eric Liu, Santa Clara, CA (US); Seung Wook Kim, Cupertino, CA (US)

(72) Inventors: Stefan MARTI, Santa Clara, CA (US); Eric Liu, Santa Clara, CA (US); Seung Wook Kim, Cupertino, CA (US)

(21) Appl. No.: 13/235,095

(22) Filed: Sep. 16, 2011

(51) Int. Cl. G06F 3/01

(52) U.S. Cl. 715/704

(57) ABSTRACT

A method for operating a computing device is disclosed, where data that associates a user action at a predetermined location with a programmatic action is stored in memory. A user action being performed at the predetermined location is detected, and the corresponding programmatic action is performed in response to detecting the user action being performed at the predetermined location.

### TECHNICAL FIELD

The disclosed embodiments relate to a system and method for linking computational actions to user actions at particular locations for a computing device.

### BACKGROUND

Typically, a computing device includes a display that presents various icons that represent files, applications, folders, or other items associated with the computing device. A user can then select (e.g., double click with a mouse, or tap on a touchscreen) an icon in order to launch a corresponding application or open a file or folder. However, some icons are not self-explanatory or intuitive to recognize, and some displays are small in size so that the number of icons that are presented on a desktop, home page, or application launcher, for example, are limited.

Furthermore, a user's spatial memory is not fully used to remember the exact location of various icons on a desktop or application launcher user interface provided on a display of the computing device. As a result, the desktop metaphor of a computing device is not actually close to reality—particularly from a human's perspective.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates a system for linking programmatic actions to user actions at various locations, and for performing a programmatic action corresponding to a detected user action, according to an embodiment;

FIG. 2 illustrates a method for linking programmatic actions to user actions at various locations, and for performing a programmatic action corresponding to a detected user action, according to an embodiment;

FIG. 3 illustrates a method for linking programmatic actions to user actions, under an embodiment;

FIG. 4 illustrates a method for detecting a user action being performed at a location, according to an embodiment; and

FIG. 5 illustrates a hardware diagram of a computing device for linking programmatic actions to user actions at various locations, and for performing a programmatic action corresponding to a detected user action, according to one or more embodiments.

### DETAILED DESCRIPTION

Embodiments described herein include a system and method for enabling a user to associate programmatic actions of a computing device with one or more user actions that are performed apart from the computing device (e.g., at a designated relative region). According to some embodiments, a user can translate physical actions that are seemingly independent of a computing device interface, such as user interaction with an object or space about a computing device, into an input with a computing device.

In some embodiments, a device is configured to enable a user to link or otherwise associate a user action, specific to a location or item (e.g., touching a drawer on a desk with a stylus or pointing device), with a programmatic action (e.g., launch a file directory). One result that can be achieved is that the user can perform the associated action in the future to trigger the device into performing the corresponding programmatic action.

Among other benefits, embodiments enable diverse and intuitive operation of a computing device through use of spatial and/or object sensing. Embodiments enable, for example, the user to associate the user action and/or location and/or object with a programmatic action, so that the user can operate the computing device in some manner by interacting with a spatial region or object other than the computing device. For example, a user can be enabled to create certain shortcuts and the system has flexibility to adapt to a user's unique workspace, home, environment, etc. As used herein, “spaced apart” or “separate from” can refer to an object being physically separated from the computing device, and is intended to refer to a distance range that is greater than that which can be sensed through capacitive sensors (e.g., touchscreen).

In some embodiments, a computing device stores data corresponding to a user action at a particular location with a linked or associated programmatic action, and that detects the location or position of an object that is used to perform the user action.

According to an embodiment, data that associates a user action at a predetermined location with a programmatic action is stored in a memory resource of a computing device. The predetermined location is spaced apart or at a distance away from the computing device. The user action may also be performed with an object, such as a stylus or pointing device, that is associated with the computing device. Upon detecting the user action being performed at the predetermined location, based at least in part on the position of the object, a corresponding programmatic action is performed by the computing device. In some embodiments, the user is enabled to link or associate a plurality of different user actions at a plurality of locations with a plurality of different programmatic or computational actions.

In other embodiments, a user may operate a program or application on the computing device, or configure the computing device to operate in a linking mode in order to associate a user action at a location with a programmatic action. The user can associate a user action at a particular location with a programmatic action so that the computing device can store the linked information in a memory resource of the device. The program or application, or linking mode may provide a user interface feature on a display of the computing device that provides a plurality of possible programmatic actions that may be performed by the computing device. In this manner, the user may perform a user action at a particular location, and choose or select a programmatic action to be linked to that user action at the particular location. This information is then stored in the memory resource of the computing device.

A programmatic action of a computing device may correspond to launching or opening a program, application, file, folder, settings for a computing device, or any other action that can be performed by the computing device (e.g., saving a document, making a copy of a file, deleting a file or folder, showing the current time or date, etc.). In some embodiments, the programmatic action may also result in a change in the state of the computing device (e.g., lock or unlock, sleep or standby mode), and/or cause a user interface feature or mechanism (e.g., speakers, camera, microphone, keyboard, display, etc.) to provide output or be activated in order to receive user input or perform a designated function.

The computing device can detect a position of an object that is used to perform the user action by using a variety of different techniques. In some embodiments, various triangulation methods can be used, such as ultrasonic triangulation, radio-frequency (RF) triangulation, or infrared (IR) triangulation. In other embodiments, the computing device may employ a trilateration method to detect the position of the object.

According to an embodiment, the object that is used to perform the user action may be a variety of different devices, such as, but not limited to a stylus or pointing device, a ring, a watch, a bracelet, another mobile device, or any other device that can be worn or attached to a finger, hand, wrist or arm of the user. In some embodiments, the object may include an input mechanism, such as a button, keys, keyboard, etc., so that the user can press the input mechanism in order to cause the computing device to perform a corresponding programmatic action when the object is sufficiently proximate to or near the linked or associated user action at a predetermined location.

In some embodiments, the computing device may detect the position of the object that is used to perform the user action when the computing device is in a tracking (or position detecting) state. The tracking or position detecting state may be operating at all times, or can be turned on/off according to user preference. According to an embodiment, when the computing device detects a position of the object associated with a user action, the computing device looks through the plurality of stored linked information to determine whether the current position of the object corresponds to a particular location stored in the memory as part of the stored linked information. Upon determining that the current user action with the object is at a position that is associated with a corresponding programmatic action, the computing device automatically performs the corresponding programmatic action.

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein may be implemented using programmatic modules or components. A programmatic module or component may include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein may generally require the use of computers, including processing and memory resources. For example, one or more embodiments described herein may be implemented, in whole or in part, on computing machines such as desktop computers, cellular phones, laptop computers, printers, digital picture frames, and tablet devices. Memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and PDAs), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

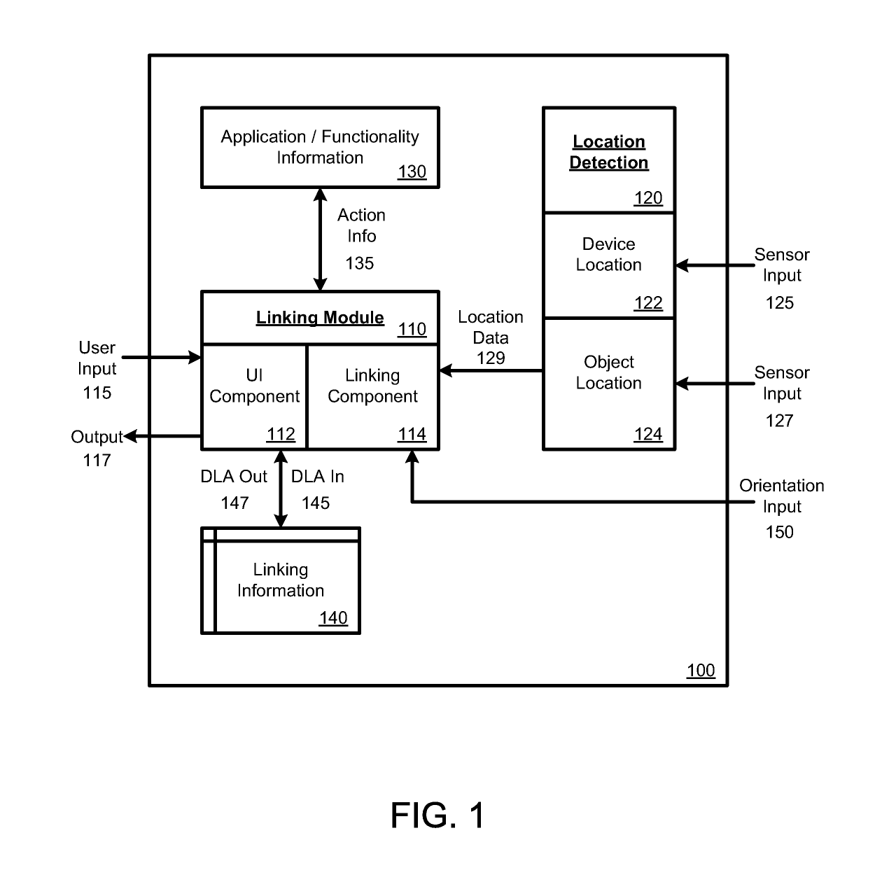

FIG. 1 illustrates a system for linking programmatic actions to user actions at various locations, and for performing a programmatic action corresponding to a detected user action, according to an embodiment. A system such as described with respect to FIG. 1 may be implemented on, for example, a mobile computing device or small-form factor device, or other computing form factors such as a tablet, notebook, or desktop computer. In one embodiment, system 100 enables a user to associate (or link together) a plurality of user actions at various locations or positions with a plurality of programmatic or computational actions, respectively, that are performed by the computing device. After associating the plurality of user actions at various locations with the plurality of programmatic actions, the computing device may perform a corresponding programmatic action when it detects a position of an object (that is used by the user to perform the user action) at an associated location. In this manner, the computing device can automatically perform a function in response to a user action.

According to an embodiment, system 100 includes a linking module 110 to enable a user to associate a user action at a particular location with a programmatic action of the computing device. A programmatic action (or function) may include launching (e.g., starting or opening) a program, application, file, folder, settings for a computing device, or any other action that can be performed by the computing device. In other embodiments, other programmatic actions include actions or functions that can be performed while a user operates a particular application that is currently running on the computing device (e.g., if a browser is currently running on the computing device, a programmatic action can be to open a new browsing window, return to a previous webpage, etc.). In some embodiments, the programmatic action may result in a change in the state of the computing device (e.g., lock or unlock a device, set to a sleep or standby mode), and/or cause a user interface feature or mechanism (e.g., speakers, camera, microphone, keyboard, display, etc.) to provide output or be activated in order to receive user input or perform a designated function.

In an embodiment, the linking module 110 includes a user interface (UI) component 112 and a linking component 114. The UI component 112 includes one or more interfaces (e.g., display interface, button press) to enable the user to define a spatial action (performed apart from the computing device) and its corresponding programmatic value or action. The interfaces can be implemented through a display (e.g., touchscreen), audio input, sensor input (e.g., proximity sensor), buttons, or camera (or optical sensor). In one implementation, the UI component 112 generates a display component to enable the user to associate or link a programmatic action with a user action at a location. In some embodiments, the UI component 112 provides a user interface of options or a list of possible programmatic functions or actions that can be selected by the user. The UI component 112 receives user input 115 for selecting a programmatic action to be associated with a particular user action at a location.

In some embodiments, the user may launch an application or program in order to manually associate different programmatic actions with various user actions at locations (e.g., the application or program can be a program for specifically allowing a user to program or associate the different functions with user actions at locations). In another embodiment, the user can configure the computing device to operate in a specific mode (e.g., a linking mode) so that the user can associate a plurality of different actions before exiting the mode (e.g., before placing the computing device in a normal operating mode). In such implementations, the UI component 112 provides a user interface to enable the user to associate programmatic actions with user actions at different locations.

In response to the user selection via the user input 115, the linking component 114 associates or links a selected programmatic action with a user action at a particular location. The linking component 114 receives location data 129 from location detection 120, which provides information corresponding to both the location of the computing device and the location of the object. As discussed, the object is used by a user to perform the user action at a particular location. After associating or linking the programmatic action with a user action at a particular location, the linking component 114 sends the device linked action (DLA) data 145 to linking information 140 to store the data. In one embodiment, linking information 140 stores a table of a plurality of different device linked action data 145, where each DLA data 145 corresponds to a programmatic action that is associated with a user action at a location. Such information and tables can be stored in a memory resource of a computing device.

As discussed, the linking component 114 receives location data 129 from location detection 120. Location detection 120 receives a plurality of input data from various sensors of a computing device. In one embodiment, device location 122 receives sensor input 125 from location mechanisms that provide input about the location of the computing device itself. Sensor input 125 can be provided by, for example, location aware resources, such as a global positioning system (GPS) or other navigation or geolocation systems, that provide information about the location of the computing device. Such information can correspond to general location information, such as city or zip code or address, or correspond to specific latitude and longitude coordinates. Similarly, object location 124 receives sensor input 127 that corresponds to the location of an object (that is associated with the computing device) that is used to perform the user action. In other embodiments, the linking component 114 may also receive orientation input 150 from other sensory mechanisms, such as an accelerometer, a gravitometer and a magnetometer, to provide the orientation of the computing device (e.g., which direction it is facing—north, south, etc., or which orientation it is being held or placed—portrait, landscape). Such information may be relevant for determining an absolute position of an object.

Sensor input 127 provides location information about the object (e.g., the position of the object relative to the computing device) to object location 124. Various methods and techniques may be used by the computing device to receive location information about the object. According to an embodiment, some technologies that allow for a position of an object to be detected at a distance away from the computing device include ultrasonic triangulation, radio-frequency (RF) triangulation, and infrared (IR) triangulation. In one embodiment, the computing device can use ultrasonic triangulation to determine the position or location of the object. In ultrasonic triangulation, the object includes a speaker that emits an ultrasonic signal to the computing device. The computing device includes three or more microphones (or receptors) that receive the ultrasonic signal from the object, and use the difference in timing and signal strength to determine the object's location and movement.

In another embodiment, the computing device can employ RF triangulation to determine the position or location of the object relative to the computing device. In RF triangulation, the object includes a RF emitter that transmits an RF signal. The computing device includes three or more RF antennas to receive the RF signal from the object, and use the difference in timing and signal strength to determine the object's location and movement. In other embodiments, IR triangulation can be used by the computing device. In IR triangulation, the object includes an IR emitter that emits and IR signal. The computing device includes three or more IR detectors to receive the IR signal, and use the difference in timing and signal strength to determine the object's location and movement.

Alternatively, other methods, such as multilateration or trilateration can be used by the computing device to determine position or location information about the object. In one embodiment, a signal emitter can be added to the computing device and the three or more sensors can be added to the object held by the user. The computing device can then emit a signal (e.g., ultrasound, RF, IR), which is picked up by the three or more sensors on the object. The processing of the information (e.g., trilateration) provided by the sensors can occur at the object or at the computing device. One advantage of this technique is that multiple objects, such as multiple styluses or pointing devices, may be used in parallel (or conjunction) with the computing device. Another advantage provides for the transmission power of the emitting signal to be increased because the computing device is less power restricted than a mobile object, such as a stylus. Once the position or location of the object is determined by any of the above-described techniques at a particular time, the sensor input 127 can be provided to object location 124 to provide object location information.

The linking module 110 also receives programmatic action information 135 from application/functionality information 130. Application/functionality information 130 provides a plurality of different programmatic actions that can be performed by the computing device. In some embodiments, programmatic actions can include launching or opening an application (e.g., a browser, a word processor, a calendar application, contacts application, messaging application, a game, etc.), or other functions that can be performed by the computing device (e.g., displaying the current time or weather, changing a state of the computing device, or a function that is performed with a currently operating application). The UI component 112 can receive the different action information 135 for the programmatic actions and provide the plurality of programmatic action information 135 to a user. The user may then access the user interface feature generated by the UI component 112 and select programmatic actions to be associated with user actions at different locations.

According to an embodiment, because the linking module 110 receives location data 129 (about the computing device and the object) and programmatic action information 135, and provides a user interface for a user, the user may associate a user action at a particular location with a programmatic action via a user input 115. The linking component 114 keeps track of the device linked actions and stores the DLA data 145 in linking information 140. This DLA data 145 can then be accessed at a later time. For example, the user may be operating a desktop computer at her office, and knows that the telephone is located on her desk to the left of her monitor. The user may operate the object, such as a stylus, and perform a user action by tapping on the telephone. The user can designate or associate that particular user action with a programmatic action, such as opening a contacts application or program (e.g., contacts from Outlook). The user can then perform a similar action with the object on the telephone to cause the desktop computer to automatically launch the contacts application. In this manner, the user can use her 3D spatial memory to operate the computing device without having to minimize windows or find a particular application or icon.

As discussed previously, in some embodiments, a user may enter a configuration mode (e.g., a linking mode) or launch an application in order to manually associate certain user actions at locations with different programmatic actions that are to be performed by the computing device. Once the user programs or associates user actions at different locations with programmatic actions (e.g., a user can designate ten device linked actions, or more or less), the user can exit out of the configuration mode or close the application used. The DLA data 145 is saved or stored in linking information 140 so that the linking module 110 can access the data at a later time.

When the user operates the computing device, the user can move the object to a location or position that is spaced apart or separate from the computing device. For example, the computing device can be a tablet device with a touch screen that can receive input from an object, such as a stylus. As the user operates the table device, the user can move the stylus to locations outside of the touch screen display of the tablet (e.g., if the tablet is on a dock on a desk, the user can perform a user action with the stylus on the desk drawer). Upon the computing device detecting the user action at the desk drawer, a linked programmatic action can be automatically performed by the computing device.

According to an embodiment, the computing device constantly monitors or detects the current position of the object used by the user to perform a user action (e.g., using a triangulation method, the signal emitter from the object can emit a signal every second or every millisecond, etc.). Using a technique as described above, object location 124 receives sensor input 127 that provides information regarding the location or position of the object. Sensor input 127 can also include other information corresponding to the object, such as whether a user pressed an input mechanism on the object itself, or how long the user has held the object in a particular position or location. Location detection 120 provides location data 129 to the linking module 110. The location data 129 includes information corresponding to the location of the object.

In some embodiments, periodically, the linking module 110 receives location data 129 from location detection 120 and checks the DLA data stored in the linking information 140. Upon determining that the current user action at a particular location corresponds to an associated programmatic function (e.g., by looking through a table stored in the linking information 140 and comparing different entries, etc.), the linking module 110 receives DLA data 147 from linking information 140, and based on the DLA data 147, enables the UI component 112 to provide an output 117 corresponding to the programmatic action. Depending on the programmatic function that is to be performed, the UI component 112 can output data 117 to present a user interface on the display (e.g., if an application is launched, such as a web browser, the browser user interface is provided on the display) or cause another user interface mechanism (e.g., speakers to play music) to be activated or operated.

Methodology

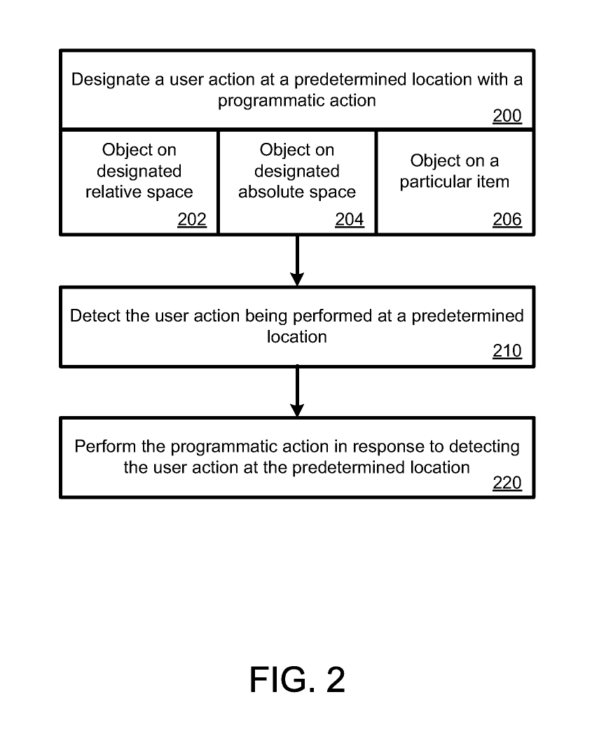

Methods such as described by an embodiment of FIG. 2 through may be implemented using, for example, components described with an embodiment of FIG. 1. Accordingly, references made to elements of FIG. 1 are for purposes of illustrating a suitable element or component for performing a step or sub-step being described. FIG. 2 illustrates a method for linking programmatic actions to user actions at various locations, and for performing a programmatic action corresponding to a detected user action, according to an embodiment.

In FIG. 2, a user action at a predetermined location is designated with a programmatic action (step 200). A user can access a user interface that is provided on a display of the computing device to select a programmatic action to be associated with a user action. In some embodiments, the user action can include a button press on an input mechanism of an object (i.e., the object is used by the user to perform the user action) when the object is at a position or location that is separate from or spaced apart from the computing device. The user action can also correspond to placing an edge or point of the object (e.g., a point of a stylus) on a surface of another item (e.g., a desk surface, a file cabinet, a window, a telephone, etc.). In other embodiments, the user action can correspond to a user holding the object at a particular location for a predetermined or specific amount of time. The user action can also be a movement made with the object itself (because the object location can be tracked by the computing device, using techniques described above), such as making a circle on a surface of an item using the object, such as a stylus. Each of the user actions includes a location of the object used to perform a particular user action.

In some embodiments, step 200 includes storing data that associates a user action at a location with a programmatic action. This can be done a number of times, depending on how many different user actions the user associates with programmatic actions. As discussed with respect to FIG. 1, this data can be stored in a table in a memory resource of the computing device.

According to an embodiment, sub-steps 202, 204 and 206 may be a part of step 200 or be in addition to what is described in step 200. As discussed, a user action at a particular location can include a variety of different actions. In sub-step 202, the object (that is used to perform the user action) can be positioned in free space or placed on a surface of an item (such as a window, desk surface, printer, etc.), where the location of the object is designated relative to the computing device. For example, in some embodiments, the computing device can be a mobile device, such as a cellular phone, PDA, or tablet device, so that a user can point and tap the object on a surface/item at a location relative to the mobile device (e.g., the object is tapped down on top surface of a desk, at a distance of two feet from the edge of the mobile device). This user action at the relative location can then be designated or associated with a programmatic action (e.g., show the desktop with all the windows minimized). In this manner, the user can sit at another desk in another room or at a different location entirely, and the user can use his or her 3D spatial memory to perform the same or similar user action (e.g., tap the object on a surface at a location similar to the location previously tapped with respect to the mobile device) in order to cause the same programmatic action to be performed.

In another embodiment, the user action (e.g., button press on the object while at a location separate from or spaced apart from the computing device, holding the object for a predetermined amount of time at a location, making a circular motion, etc.) can be positioned in free space or placed on a surface of an item, where the location of the object is designated at an absolute location (sub-step 204). As discussed, the computing device may detect its own location using various location detection mechanisms (e.g., GPS). For each user action at a location that is associated programmatic action (e.g., DLA data), the computing device can also store the data of its own location. In this manner, the computing device can keep track of user actions that are performed by a user in certain absolute locations. Furthermore, orientation input, such as input from an accelerometer, gravitometer, magnetometer, and other location aware resources, can be used to complement the relative localization methods.

For example, the computing device can determine that the user has set it on a desk in the user's office, and that it is facing a certain direction (e.g., north). When the user designates a user action on a physical window that is five feet from the computing device, the computing device can keep track of the location of the object as well as the programmatic action that is designated with that user action on the physical window (e.g., present info showing the current weather on the display of the computing device). In this embodiment, the computing device would not automatically perform the programmatic action if the same user action was made on a surface five feet from the computing device when the computing device is not on the desk of the user's office, but is instead on a dining table at the user's home.

In some embodiments, computing devices, such as desktops, can be more stationary than other computing devices (e.g., harder to move so that it less portable than mobile devices), so that user actions at locations are at an absolute location (because the monitor and desktop tower are stationary). In other embodiments, the computing device can be rested or plugged into a dock or charging port at a particular location, so that the computing device knows its location when placed in the dock. When the computing device is placed in the dock, user actions can be designated to be at absolute locations.

According to other embodiments, the user can designate a user action with a particular item (e.g., a telephone, a file cabinet, a printer) using relative localization and/or absolute localization (sub-step 206). In one embodiment, the user interface feature provided on a display of the computing device can also enable a user to tag a user action at a location with both (i) a programmatic action, and (ii) the identify of a particular item on which the user action is performed on. By using relative localization and/or absolute localization, and by identifying the item that is being linked with a programmatic action, a user can use his or her spatial memory to easily operate the computing device. In an alternative embodiment, a user can designate a user action with a particular item by using, for example, infrared (IR) dots. The object, such as a pointing device, can include a camera that detects IR dots on a particular item. These IR dots can be printed directly on items, such as wallpaper, or on papers or stickers that can be placed on items. The object can detect a pattern by reading the IR dots, and can determine the item and/or location so that a user can designate the user action on the item with a programmatic function.

After the associated or linked data is stored in a memory of the computing device, a user can perform user actions at various locations around or near the computing device. The computing device monitors the user actions (via the location and position of the object) and detects whether the user action is being performed at a predetermined location (e.g., a location that has been associated or linked with a programmatic function) (step 210). For example, if the user action is being performed on a desk surface three feet to the right of the computing device, and that particular location is not a predetermined or linked location, the computing device will not automatically perform a programmatic action.

In some embodiments, a user's current action can be detected by constantly monitoring the object that is used by the user to perform a user action. For example, the object can emit a signal (as discussed with respect to triangulation) periodically and the computing device can periodically monitor the object's location or position. In another embodiment, the user can activate a setting or mode for the computing device, which directs the computing device to track the location and position of the object. When the computing device is not in this mode, for example, the user can perform a variety of user actions at different locations that are not detected by the computing device. Still, in another embodiment, the user can manually press an input mechanism on the object to cause the object to emit a RF signal or IR signal or ultrasound signal, thereby directing the computing device to receive information regarding the position and location of the object.

Upon determining that the user's action is at a predetermined location, the computing device will automatically perform a corresponding programmatic action (step 220). As discussed above, a programmatic action can include launching or opening an application, changing a state of the computing device (e.g., locking or unlocking the computing device, or turning off a display), or performing some other computing device functionality. In some embodiments, as discussed above, a corresponding programmatic action can be performed when the computing device is operating in a specific setting or mode, or when the user provides an input (or inputs) using an input mechanism on the object.

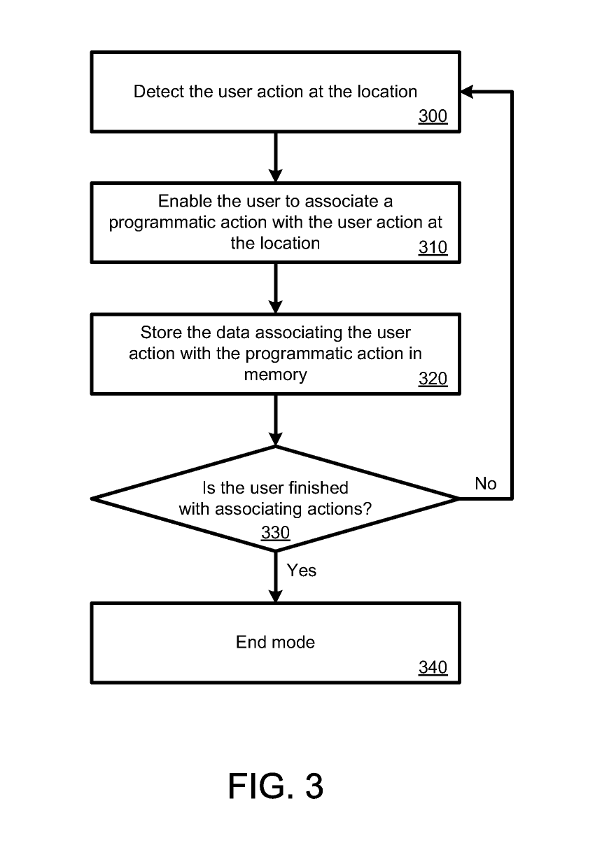

FIG. 3 illustrates a method for linking or associating programmatic actions to user actions, under an embodiment. FIG. 3 may be included or may be part of the method as described with FIG. 2. At step 300, the computing device detects a user action at a particular location. This can be performed using the system and methods described with respect to FIGS. 1 and 2. According to an embodiment, a user can configure the computing device to operate in a mode (such as a linking mode), or can run an application or program for associating various programmatic actions with user actions made with an object.

In one embodiment, a user interface can be provided on a display of the computing device to enable a user to associate a programmatic action (from a plurality of programmatic actions that can be performed by the computing device) with a particular user action at a location (step 310). For example, upon detecting the user action at the location, the user interface may provide selectable options for a user (e.g., show that a user action at a location was detected, and present a list of possible programmatic actions that can be associated with the location).

In response to the user associating a programmatic action with a user action at a particular location, the computing device can store the data (e.g., DLA data) in a memory resource of the computing device (step 320). According to some embodiments, the different DLA data (each corresponding to a linked programmatic action with a user action) can be stored in a table that can be accessed by the computing device. In some embodiments, the user can access the stored data to see or view on a user interface what programmatic actions have been associated with user actions at different locations. This enables the user to make change or alter certain designations that have already been made.

At step 330, the computing device makes a determination whether the user is finished associating user actions at different locations with programmatic actions of the computing device. If the computing device determines that the user is not finished, the computing device continues to monitor the object (used by the user to perform user actions at locations) to detect user actions. In this way, the user can associate a plurality of different programmatic actions with a plurality of different user actions at various locations. On the other hand, if the computing device determines that the user is finished associating programmatic actions with user actions, the computing device exits the setting or mode, or closes the application or program (step 340). In some embodiments, the user can exit the settings or mode, or manually close the application or program.

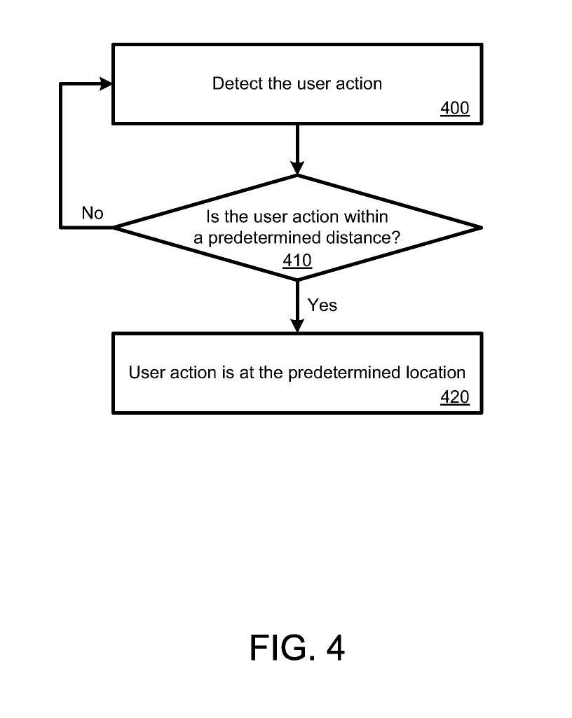

FIG. 4 illustrates a method for detecting a user action that is being performed at a location, according to an embodiment. FIG. 4 may be included or may be a part of the method as described with FIG. 2. In some embodiments, FIG. 4 may be performed after a user has already finished associating or linking programmatic actions with user actions at different locations (e.g., after DLA data has been stored in memory). At step 400, the computing device detects a user action at a particular location. This can be performed using the system and methods described with respect to FIGS. 1 and 2. In one embodiment, a user can configure the computing device to operate in a mode (such as a linking mode), or can run an application or program for detecting user actions made with an object.

In some embodiments, when the user associates various user actions with programmatic actions (such as described with FIGS. 2 and 3), a zone of tolerance is included with the location of the user action. A zone of tolerance is an area that surrounds or encircles the predetermined location of the object when the user action is detected and associated with a programmatic action. The zone of tolerance enables a user to perform a user action at a location that is close to or near the predetermined location (e.g., if the user action is a tap on a surface of a desk, the zone of tolerance can be a circle with the center being the location of the tap and a radius of five inches from the center) so that the user does not have to perform the exact same action at the exact same location. This enables the user to have some flexibility in performing the action.

The zone of tolerance can have a predetermined distance from the location of the user action (e.g., the location of the object). This predetermined distance can be configured by a user when designating certain user actions with programmatic actions, or can be automatically set to a certain size/distance. The zone of tolerance can have a variety of different shapes (e.g., circular, hexagonal, rectangular, etc.). In some embodiments, the zone of tolerance can be dynamically altered or adjusted by the computing device depending on the total number of user actions that have been associated with programmatic actions. In other embodiments, the zone of tolerance can be dynamically altered depending on the number of user actions that are within a specified distance or area of each other.

For example, a user can designate multiple user actions on a surface of a desk. A first user action can be the object being touched to a telephone on the left side of the desk (which causes a contact application to be launched on the computing device), a second user action can be the object being touched to the center of the desk (which causes all windows on the display of the computing device to be hidden), and a third user action can be the object being touched to the lamp on the right side of the desk (which causes the display screen to be turned on or off). In one embodiment, the zone of tolerance for each of the locations of the three user actions can be the same size (e.g., five inch radius/distance from the location of each user action) or different sizes depending on the location of the user actions relative to each other (e.g., if the first user action is at a location that is close to the location of the second user action and the location of the third user action is far from the first and second locations, the location of the third user action may have a larger zone of tolerance). In another example, if the user designates a fourth programmatic action with a user action at a location within the five inch radius of the telephone (e.g., the location of the first user action), the zone of tolerance can dynamically change in size so that the two zones do not overlap each other (e.g., the zones can change to be a circle with a two inch radius from the location of the first user action, and another circle with a two inch radius from the location of the last user action). According to another embodiment, the user can make or move the object in a circle, for example, as the user action to create a zone of tolerance of a particular size.

At step 410, after detecting the user action at a location, the computing device makes a determination whether the detected user action is within a predetermined distance of a predetermined location (e.g., if the detected user action is within a zone of tolerance of a predetermined location that is associated with a programmatic action). In one embodiment, if the user action is at a location that is not within the predetermined distance or zone of tolerance, the computing device continues to monitor the object's location to determine other user actions (back to step 400). If the user action is at a location that is within the predetermined distance of the predetermined location (or within the zone of tolerance), then the user action is determined to be performed at the predetermined location (step 420). In response, the computing device can automatically perform a corresponding programmatic action (see FIG. 2).

Hardware Diagram

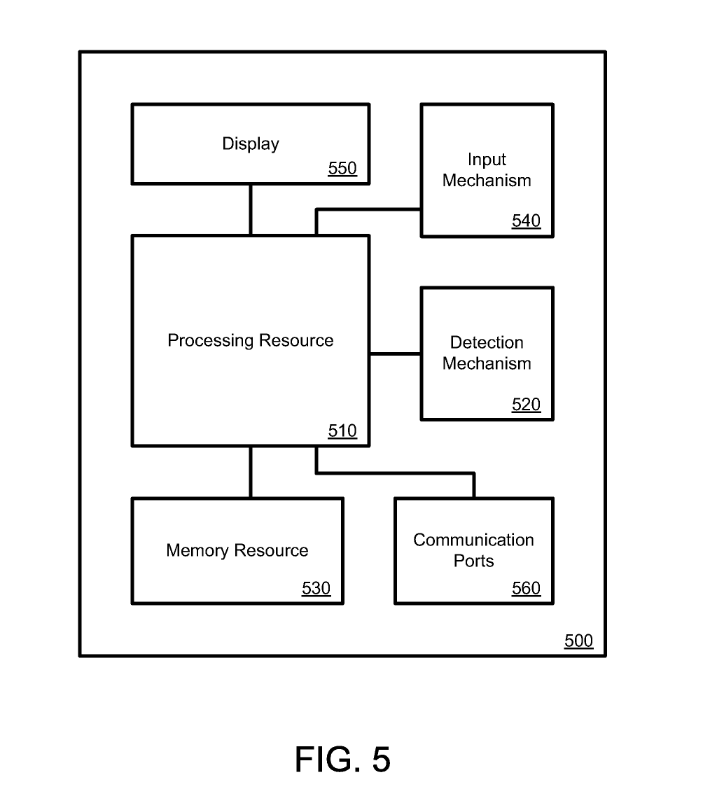

FIG. 5 is a block diagram that illustrates a computer system upon which embodiments described herein may be implemented. For example, in the context of FIG. 1, system 100 may be implemented using a computer system such as described by FIG. 5.

In an embodiment, computing device 500 includes a processing resource 510, detection mechanism 520, memory resource 530, input mechanism 540, display 550 and communication ports 560. The processing resource 510 is coupled to the memory resource 530 in order to process information stored in the memory resource 530, perform tasks and functions, and run programs for operating the computing device 500. The memory resource 530 may include a dynamic storage device, such as random access memory (RAM), and/or include read only memory (ROM), and/or include other memory such as a hard drive (magnetic disk or optical disk). Memory resource 530 may store temporary variables or other intermediate information during execution of instructions (and programs or applications) to be executed by the processing resource 510.

In some embodiments, the processing resource 510 is also coupled to various detection mechanisms 520, such as accelerometers, gravitometers, magnetometers, and location aware resources, such as global positioning services (GPS). Using data provided by the detection mechanisms 520, the processing resource 510 may detect the location and orientation of the computing device 500.

The computing device 500 may include a display 550, such as a cathode ray tube (CRT), a LCD monitor, an LED screen, a touch screen display, etc., for displaying information and/or user interfaces to a user. Input mechanism 540, including alphanumeric keyboards and other buttons (e.g., volume buttons, power buttons, and buttons for configuring settings), is coupled to computing device 500 for communicating information and command selections to the processing resource 510. Other non-limiting, illustrative examples of input mechanism 540 include a mouse, a trackball, a touchpad, a touch screen display, or cursor direction keys for communicating direction information and command selections to the processing resource 510 and for controlling cursor movement on display 550. Embodiments may include any number of input mechanisms 540 coupled to computing device 500.

Computing device 500 also includes communication ports 560 for communicating with other devices and/or networks (both wirelessly and through use of a wire). Communication ports 560 may include wireless communication ports for enabling wireless network connectivity with a wireless router, for example, or for cellular telephony capabilities (e.g., when the computing device 500 is a cellular phone or tablet device with cellular capabilities). Communication ports 560 may also include IR, RF or Bluetooth communication capabilities, and may enable communication via different protocols (e.g., connectivity with other devices through use of the Wi-Fi protocol (e.g., IEEE 802.11(b) or (g) standards), Bluetooth protocol, etc.).

Embodiments described herein are related to the use of the computing device 500 for implementing the techniques described herein. According to one embodiment, the techniques are performed by the computing device 500 in response to the processing resource 510 executing one or more sequences of one or more instructions contained in the memory resource 530. Such instructions may be read into memory resource 530 from another machine-readable medium, such as an external hard drive or USB storage device. Execution of the sequences of instructions contained in memory resource 530 causes the processing resource 510 to perform the process steps described herein. In alternative embodiments, hard-wired circuitry may be used in place of or in combination with software instructions to implement embodiments described herein. Thus, embodiments described are not limited to any specific combination of hardware circuitry and software.

Alternatives and Variations

Numerous alternatives and variations exist to embodiments described herein. In one embodiment, the object (that is used by a user to perform user actions) may include a projection module or display in order to display textual or graphic data onto a physical item based on the content or functionality of the corresponding programmatic action. The textual or graphic data may be automatically generated when the computing device detects that the user action at the predetermined location (or item) is linked or associated with a programmatic action. In other embodiments, the projection module (e.g., a micro projector that displays content on a surface, or a small display screen on the object) can be used for displaying thumbnails, previews or other widgets.

Examples of textual or graphic data that are displayed include:

| User Action on an | Associated Programmatic | Textual or Graphic |
|---|---|---|
| Object or Location | Action | Data to be Displayed |
| File drawer | Open file directory | Show # of files, sizes |
| Window | Open weather application | Show current outside |
| | | temperature |
| Telephone | Open contacts application | Show last caller |
| Coffee maker | Open calendar application | Show next meeting |
| Book shelf | Open e-reader application | Show last read book |
| Printer | Open printing menu | Show ink status |
| Picture frame | Open social network | Show most recent |
| | application | status updates |

In another variation, the object can also include mechanisms for detecting its orientation. Depending on the manner in which the user holds and moves the object while performing a user action, the user can link different programmatic actions with the user action at the same location, but for different orientations. Methods for determining orientation include using accelerometers, gravitometers and magnetometers.

It is contemplated for embodiments described herein to extend to individual elements and concepts described herein, independently of other concepts, ideas or systems, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for operating a computing device, the method being performed by one or more processors of the computing device and comprising:
storing data that associates a user action at a predetermined location with a corresponding programmatic action, the predetermined location being spaced apart from the computing device;
detecting the user action being performed at the predetermined location based, at least in part, on detecting a position of an object that is used to perform the user action; and
performing the corresponding programmatic action in response to detecting the user action being performed at the predetermined location.

2. The method of claim 1, wherein storing data that associates a user action at a predetermined location includes:
enabling a user to operate a mode of the computing device in order to associate a plurality of user actions at a plurality of locations with a plurality of programmatic actions; and
enabling the user to associate the user action at the predetermined location with the corresponding programmatic action.

3. The method of claim 2, wherein enabling a user to operate a mode of the computing device includes displaying a graphic user interface presenting one or more programmatic actions that are capable of being performed by the computing device.

4. The method of claim 1, wherein detecting a position of an object that is used to perform the user action includes using at least one or more of ultrasonic triangulation, radio-frequency triangulation, or infrared triangulation.

5. The method of claim 1, wherein the object is a stylus, a ring, a watch, a bracelet, or other device that can be worn or attached to a finger, hand or wrist of the user.

6. The method of claim 1, wherein detecting the user action being performed at the predetermined location includes making a determination that the object is positioned in a location within a predetermined distance from the predetermined location.

7. The method of claim 6, wherein the predetermined distance is altered based, at least in part, on (i) a total number of user actions at locations associated with programmatic actions of the computing device, or (ii) a number of user actions at locations associated with programmatic actions of the computing device within a specified distance of the predetermined location.

8. The method of claim 6, wherein the predetermined distance is selectable by the user.

9. A computing device comprising:
a display;
one or more memory resources; and
one or more processors coupled to the display and the one or more memory resources, the one or more processors being configured to:
store data that associates a user action at a predetermined location with a corresponding programmatic action, the predetermined location being spaced apart from the computing device;
detect the user action being performed at the predetermined location based, at least in part, on detecting a position of an object that is used to perform the user action; and
perform the corresponding programmatic action in response to detecting the user action being performed at the predetermined location.

10. The computing device of claim 9, wherein storing data that associates a user action at a predetermined location includes (i) enabling a user to operate a mode of the computing device in order to associate a plurality of user actions at a plurality of locations with a plurality of programmatic actions, and (ii) enabling the user to associate the user action at the predetermined location with the corresponding programmatic action.

11. The computing device of claim 10, wherein enabling a user to operate a mode of the computing device includes displaying a graphic user interface presenting one or more programmatic actions that are capable of being performed by the computing device.

12. The computing device of claim 11, further comprising one or more input mechanisms coupled to the one or more processors.

13. The computing device of claim 12, wherein the display is a touch screen display, and wherein the one or more input mechanisms is associated with the touch screen display.

14. The computing device of claim 9, wherein detecting a position of an object that is used to perform the user action includes using at least one or more of ultrasonic triangulation, radio-frequency triangulation, or infrared triangulation.

15. The computing device of claim 9, wherein the object is a stylus, a ring, a watch, a bracelet, or other device that can be worn or attached to a finger, hand or wrist of the user.

16. The computing device of claim 9, wherein detecting the user action being performed at the predetermined location includes making a determination that the object is positioned in a location within a predetermined distance from the predetermined location.

17. The computing device of claim 16, wherein the predetermined distance is altered based, at least in part, on (i) a total number of user actions at locations associated with programmatic actions of the computing device, or (ii) a number of user actions at locations associated with programmatic actions of the computing device within a specified distance of the predetermined location.

18. The computing device of claim 16, wherein the predetermined distance is selectable by the user.

19. The computing device of claim 9, wherein the object includes at least one or more of a display or a micro-projector, the display and the micro-projector each being configured to display information associated with the corresponding programmatic action.

20. A non-transitory computer readable medium storing instructions that are executable by one or more processors of a computing device, the instructions when executed causing the one or more processors to:
store data that associates a user action at a predetermined location with a corresponding programmatic action, the predetermined location being spaced apart from the computing device;
detect the user action being performed at the predetermined location based, at least in part, on detecting a position of an object that is used to perform the user action; and
perform the corresponding programmatic action in response to detecting the user action being performed at the predetermined location.
